(19) United States
(12) Patent Application Publication
(10) Pub. No.: US 2017/0206553 A1
(43) Pub. Date: Jul. 20, 2017

(54) PRESENTING CONTENT ITEMS TO AN ONLINE SYSTEM USER IN A SEQUENCE BASED ON USER INTERACTION WITH THE CONTENT ITEMS

(71) Applicant: Facebook, Inc., Menlo Park, CA (US)

(72) Inventors: Hans T. Lintermans, Oakland, CA (US); Shyamalan Pather, Seattle, WA (US); Elaine Brechin Montgomery, Godalming (GB); Tanmoy Chakraborty, San Mateo, CA (US)

(21) Appl. No.: 14/996,827

(22) Filed: Jan. 15, 2016

(51) Int. Cl. G06Q 30/02

(52) U.S. Cl. CPC G06Q 30/0255; G06Q 30/0277

(57) ABSTRACT

An online system allows a user to specify a sequence of advertisement requests (“ad requests”) where a set of rules identifies an order in which advertisements from the ds requests are presented to a user based on interactions by the user with presented advertisements from ad requests in the sequence. When a user interacts with an advertisement from an ad request from the sequence, the online system identifies an additional ad request from the sequence identified by a rule identifying the interaction by the user with the advertisement. The online system includes the additional ad request in one or more selection processes selecting content for presentation to the user. In some embodiments, the online system identifies an ad request from the sequence to include in the one or more selection processes based on likelihoods of the user interacting with advertisements from various ad requests in the sequence.

### BACKGROUND

This disclosure relates generally to online systems, and more specifically to selecting content to present to online system users.

Online systems, such as social networking systems, allow users to connect to and to communicate with other users of the online system. Users may create profiles on an online system that are tied to their identities and include information about the users, such as interests and demographic information. The users may be individuals or entities such as corporations or charities. Online systems allow users to easily communicate and to share content with other online system users by providing content to an online system for presentation to other users. Content provided to an online system by a user may be declarative information provided by a user, status updates, check-ins to locations, images, photographs, videos, text data, or any other information a user wishes to share with additional users of the online system. An online system may also generate content for presentation to a user, such as content describing actions taken by other users on the online system.

Additionally, many online systems commonly allow users (e.g., businesses) to sponsor presentation of content on an online system to gain public attention for a user's products or services or to persuade other users to take an action regarding the user's products or services. Content for which the online system receives compensation in exchange for presenting to users is referred to as “sponsored content.” Many online systems receive compensation from a user for presenting online system users with certain types of sponsored content provided by the user. Frequently, online systems charge a user for each presentation of sponsored content to an online system user or for each interaction with sponsored content by an online system user. For example, an online system receives compensation from an entity each time a content item provided by the user is displayed to another user on the online system or each time another user is presented with a content item on the online system and interacts with the content item (e.g., selects a link included in the content item), or each time another user performs another action after being presented with the content item.

Conventionally, a user provides a content item describing a product or a service to an online system. The content item includes information describing the product or the service for presentation to online system users. However, different users may have different levels of knowledge about the user providing the product or the service or about the product or the service. Differences in knowledge of users about products, services, or other users cause different users to differently react to different content items. For example, users with limited knowledge of a product are less likely to interact with content items describing specifics of the product, while users with more extensive knowledge of the product are less likely to interact with content items that more generally introduce a product. Conventional online systems do not account for different amounts of knowledge of a product, service, or other user when selecting content items for presentation to a user, which may reduce interactions with content items by various users and subsequently reduce revenue received by the online system.

### SUMMARY

An online system receives a sequence including multiple advertisement requests (“ad requests”). Each ad request includes advertisement content for presentation to users (also referred to as an “advertisement”) and a bid amount specifying an amount of compensation an advertiser associated with the ad request provides the online system for presenting the advertisement in the ad request, for a user interacting with the advertisement in the ad request, or for another suitable interaction with the advertisement in the ad request. Each ad request in the sequence includes a different advertisement, and s set of rules for identifying an ad request in the sequence from which an advertisement is presented to a user. A rule identifies an ad request in the sequence and one or more interactions that, when performed by a user, cause an advertisement from a different ad request in the sequence to be evaluated for presentation to the user when the online system identifies a subsequent opportunity to present one or more advertisements to the user. For example, a rule identifies an ad request and a type of interaction with an advertisement from the ad request (e.g., presentation of the advertisement to a user for at least a threshold time interval, selection of the advertisement) and an additional ad request including an advertisement for presentation in response to the online system receiving information that the user performed the type of interaction when presented with an advertisement from the ad request.

If an advertisement from an ad request in the sequence is presented to a user, the online system stores information identifying the user and the ad request in association with the user. Additionally, the online system stores information identifying interactions with the advertisement, if any, in association with the user and the ad request. When the online system subsequently identifies an opportunity to present one or more advertisements to the user, the online system selects an additional ad request from the sequence for inclusion in one or more selection processes based on the ad request previously presented to the user and interactions by the user with the advertisement from the previously presented ad request. For example, the online system identifies selects an additional ad request included in a rule that identifies the previously presented ad request and an interaction by the user with the advertisement from the previously presented ad request. As a specific example, if the user viewed at least a threshold amount of video data in the advertisement from the previously presented ad request, the online system selects an additional ad request specified by a rule that identifies viewing at least the threshold amount of video data and identifying the previously presented ad request. Hence, as the user interacts with advertisements form ad requests in the sequence, other ad requests in the sequence are subsequently evaluated for presentation to the user by the online system, presenting the user with advertisements including different information as the user interacts with advertisements from ad requests in the sequence.

Additionally, the online system stores information associated with the user identifying one or more advertisements from ad requests in the sequence presented to the user, allowing the online system to identify a progression of the user through the sequence. For example, the online system associates identifiers of ad requests from the sequence including advertisements that have been presented to the user with information identifying the user or associates an identifier of an ad request from the sequence including an advertisement most recently presented to the user with information identifying the user. In another example, the online system associates identifiers of ad requests from the sequence including advertisements with which the user performed one or more interactions, or performed specific interactions, with information identifying users. This stored information allows the online system to account for a user's progression through ad requests in the sequence when selecting selection of additional content items for presentation to the user. For example, another ad request include targeting criteria identifying an ad request from the sequence, so the other ad request is eligible for presentation to users who were presented with an advertisement from the identified ad request from the sequence and is not eligible for presentation to users who were not presented with the advertisement from the identified ad request in the sequence.

Additionally, when selecting an advertisement for presentation to a user, the online system may select an ad request from the sequence based on a likelihood of the user interacting with advertisements from different ad requests in the sequence. In various embodiments, the online system retrieves historical interactions by users with advertisements from ad requests having earlier positions in the sequence than a particular ad request and determines a likelihood of the user interacting with an advertisement from the particular ad request. If the likelihood of the user interacting with the advertisement from the particular ad request equals or exceeds a threshold value, the online system selects the particular ad request for inclusion in one or more selection processes (or for presentation to a user) without initially presenting advertisements from ad requests having positions in the sequence earlier than the particular ad request to the user. Conversely, if the likelihood of the user interacting with the advertisement from the particular ad request is less than the threshold value, the online system includes one or more of the ad request having positions in the sequence earlier than the particular ad request in the one or more selection processes. For example, the online system retrieves prior interactions with advertisements from ad requests having positions in the sequence prior to a position in the sequence of a particular ad request by users having at least a threshold number or a threshold percentage of characteristics matching characteristics of the user. Based on the retrieved interactions with the advertisements from ad requests having positions in the sequence prior to a position in the sequence of the particular ad request, the online system determines the likelihood of the user performing an interaction (e.g., a specific type of interaction) with an advertisement from the particular ad request.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is an example sequence of advertisement requests associated with rules identifying additional advertisement requests for presentation based on prior interactions with advertisements from advertisement requests in the sequence, in accordance with an embodiment.

FIG. 4 is a flowchart of a method for a method for selecting an advertisement from a sequence of advertisement requests for presentation to a user of an online system, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

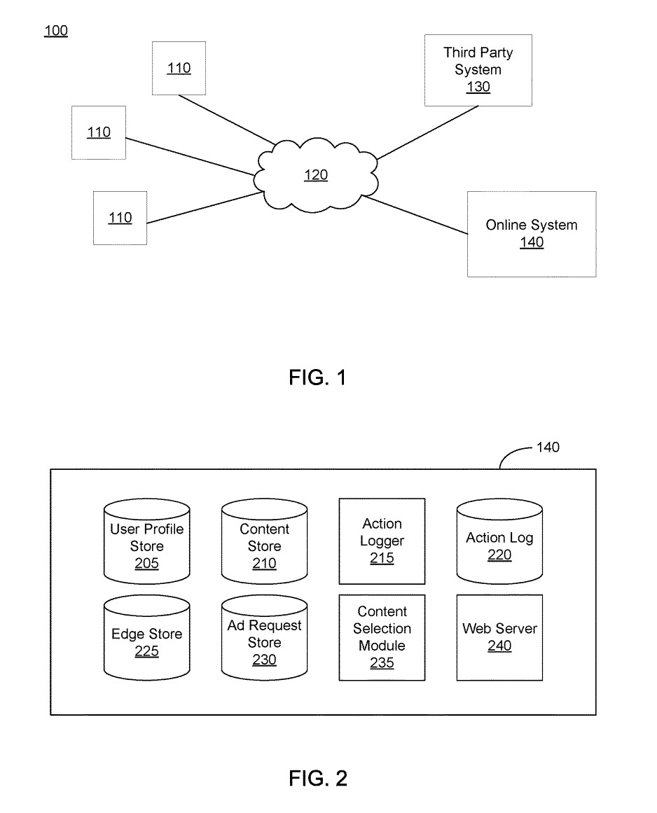

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. The embodiments described herein may be adapted to online systems that are social networking systems, content sharing networks, or other systems providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a smartwatch or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device 110. In other embodiments, a third party system 130 provides content or other information for presentation via a client device 110. A third party system 130 may also communicate information to the online system 140, such as advertisements, content, or information about an application provided by the third party system 130.

In some embodiments, one or more of the third party systems 130 provide content to the online system 140 for presentation to users of the online system 140 and provide compensation to the online system 140 in exchange for presenting the content. For example, a third party system 130 provides advertisement requests, which are further described below in conjunction with FIG. 2, including advertisements for presentation and amounts of compensation provided by the third party system 130 to the online system 140 in exchange presenting the advertisements to the online system 140. Content presented by the online system 140 for which the online system 140 receives compensation in exchange for presenting is referred to herein as “sponsored content.” Sponsored content from a third party system 130 may be associated with the third party system 130 or with another entity on whose behalf the third party system 130 operates.

FIG. 2 is a block diagram of an architecture of the online system 140. The online system 140 shown in FIG. 2 includes a user profile store 205, a content store 210, an action logger 215, an action log 220, an edge store 225, an advertisement (“ad”) request store 230, a content selection module 235, and a web server 240. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity. In some embodiments, the brand page associated with the entity's user profile may retrieve information from one or more user profiles associated with users who have interacted with the brand page or with other content associated with the entity, allowing the brand page to include information personalized to a user when presented to the user.

The content store 210 stores objects that each represents various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), engaging in a transaction, viewing an object (e.g., a content item), and sharing an object (e.g., a content item) with another user. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or a particular user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement requests (“ad requests”) are included in the ad request store 230. An ad request includes advertisement content, also referred to as an “advertisement,” and a bid amount. The advertisement is text, image, audio, video, or any other suitable data presented to a user. In various embodiments, the advertisement also includes a landing page specifying a network address to which a user is directed when the advertisement content is accessed. The bid amount is associated with an ad request by an advertiser and is used to determine an expected value, such as monetary compensation, provided by the advertiser to the online system 140 if an advertisement in the ad request is presented to a user, if the advertisement in the ad request receives a user interaction when presented, or if any suitable condition is satisfied when the advertisement in the ad request is presented to a user. For example, the bid amount specifies a monetary amount that the online system 140 receives from the advertiser if an advertisement in an ad request is displayed. In some embodiments, the expected value to the online system 140 of presenting the advertisement may be determined by multiplying the bid amount by a probability of the advertisement being accessed by a user.

Additionally, an ad request may include one or more targeting criteria specified by the advertiser. Targeting criteria included in an ad request specify one or more characteristics of users eligible to be presented with advertisement content in the ad request. For example, targeting criteria are used to identify users having user profile information, edges, or actions satisfying at least one of the targeting criteria. Hence, targeting criteria allow an advertiser to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users who have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows advertisers to further refine users eligible to be presented with advertisement content from an ad request. As another example, targeting criteria identifies users having a connection to another user or object or having a particular type of connection to another user or object.

A user, such as a business or other advertiser, may provide a sequence of ad requests to the online system 140 for storage in the ad request store 235. The sequence includes multiple advertisement requests (“ad requests”) each including a different advertisement for presentation to a user and a set of rules for identifying an ad request in the sequence from which an advertisement is presented to the user. A rule identifies an ad request in the sequence and one or more interactions that, when performed by a user, cause the online system 140 to identify another ad request in the sequence to evaluate for presentation to the user (or for presentation to the user) when a subsequent opportunity to present an advertisement to the user is identified. For example, a rule includes an identifier of an ad request in the sequence, an interaction or a type of interaction with an advertisement included in the ad request, and an identifier of an additional ad request including an advertisement for presentation to a user if the user has performed the interaction with the advertisement included in the ad request. The set of rules specifies an order of ad requests in the sequence relative to each other, with positions of ad requests in the sequence relative to other ad requests determined by interactions by users with advertisements from the ad requests identified by various rules. Any suitable interaction with an advertisement may be specified by a rule. Example interactions with an advertisement include: viewing the advertisement, viewing the advertisement for at least a threshold amount of time, viewing at least a threshold percentage of the advertisement, viewing the advertisement at least a minimum number of times, performing a specific type of interaction with the advertisement, performing at least a threshold number of a specific type of interaction with the advertisement, performing an interaction with an object associated with the advertisement, or any other suitable type of interaction.

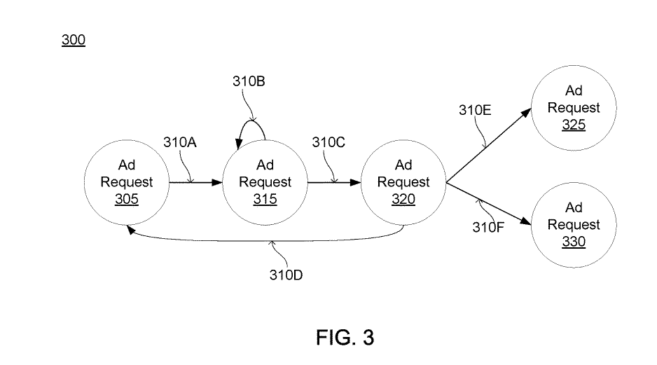

FIG. 3 shows an example sequence 300 of ad requests. In the example of FIG. 3, the sequence 300 includes ad requests 305, 315, 320, 325, 330 and rules 310A-F (also referred to individually and collectively using reference number 310). Each rule identifies an ad request, an additional ad request, and an interaction that, when performed by a user with an advertisement from the ad request, identifies an advertisement from the additional ad request as eligible for presentation to the user. In the example of FIG. 3, a rule 310A identifies the ad request 305 and an interaction with an advertisement from the ad request 305 that, when performed by a user, identifies ad request 315 as eligible for presentation to the user. For example, the rule 310A specifies that if a user is presented with the advertisement from the ad request 305, ad request 315 is then eligible for presentation to the user when the online system 140 identifies an opportunity to present an advertisement to the user. Similarly, the rule 310C identifies the ad request 315 and an interaction with the advertisement from the ad request 315 that, when performed by the user, causes the online system 140 to identify the ad request 320 as eligible for presentation to the user via another identified opportunity to present an advertisement to the user. Additionally, the rule 310B identifies the ad request 315 and an interaction with the with the advertisement from the ad request 315 that, when performed by the user, causes the online system 140 to continue identifying the ad request 315 as eligible for presentation to the user when the online system 140 identifies another opportunity to present an advertisement to the user. For example, the rule 310B identifies an interaction of viewing the advertisement from the ad request 315, while the rule 310C identifies an interaction of accessing the advertisement from the ad request 315. Hence, if the user accesses the advertisement from the ad request 315 when the advertisement is presented to the user, the online system 140 identifies the ad request 320 as eligible for presentation to the user via a subsequent opportunity to present an advertisement to the user; however, if the user merely views the advertisement from the ad request 315 when presented to the online system 140 subsequently again identifies the ad request 315 as eligible for presentation to the user, allowing the sequence to identify different ad requests as eligible for presentation to a user based on interactions by the user with advertisements presented from other ad requests in the sequence 300.

The rule 310D identifies the ad request 320 and an interaction with the advertisement from the ad request 320 that, when performed by the user, causes the online system 140 to identify the ad request 305 as eligible for presentation to the user via another identified opportunity to present an advertisement to the user. This allows the online system 140 to present an advertisement form an earlier ad request 305 in the sequence 300 if the user performs a certain interaction, such as viewing the advertisement form the ad request 320 for less than a threshold amount of time or viewing less than a threshold percentage of the advertisement from the ad request 320. Identifying an earlier ad request 305 in the sequence 300 as eligible for presentation to the user allows the online system 140 to present the user with an advertisement from the sequence 300 with which the user previously interacted to increase a likelihood of the user interacting with an advertisement from the sequence 300. Additionally, rule 310E identifies the ad request 320 and an interaction with the advertisement from the ad request 320 that, when performed by the user, causes the online system 140 to identify the ad request 325 as eligible for presentation to the user via another identified opportunity to present an advertisement to the user, while rule 310F identifies the ad request 320 and an interaction with the advertisement from the ad request 320 that, when performed by the user, causes the online system 140 to identify the ad request 330 as eligible for presentation to the user via another identified opportunity to present an advertisement to the user. For example, the rule 310E identifies the ad request 325 as eligible for presentation to the user if the user shares the advertisement from the ad request 320 with another online system user, while the rule 310F identifies the ad request 330 as eligible for presentation to the user if the user views the advertisement from the ad request 325 for greater than a threshold amount of time. Hence, different rules 310D, 310E, 310F identify the ad request 325, causing the online system 140 to identify different ad requests 305, 325, 330 from the sequence 300 for presentation to the user based on an interaction by the user with the advertisement from the ad request 325 or to identify different ad requests 305, 325, 330 from the sequence 300 for presentation to different users based on interactions by the different users with the advertisement from the ad request 325. This allows the online system 140 to present advertisements from ad requests in the sequence 300 in different orders relative to each other based on how a user interacts with advertisements presented to the user from different ad requests in the sequence 300.

Referring back to FIG. 2, the content selection module 235 selects one or more content items for communication to a client device 110 to be presented to a user. Content items eligible for presentation to the user are retrieved from the content store 210, from the ad request store 230, or from another source by the content selection module 235, which selects one or more of the content items for presentation to the user. A content item eligible for presentation to the user is a content item associated with at least a threshold number of targeting criteria satisfied by characteristics of the user or is a content item that is not associated with targeting criteria. In various embodiments, the content selection module 235 includes content items eligible for presentation to the user in one or more selection processes, which identify a set of content items for presentation to the user. For example, the content selection module 235 determines measures of relevance of various content items to the user based on characteristics associated with the user by the online system 140 and based on the user's affinity for different content items. Information associated with the user included in the user profile store 205, in the action log 220, and in the edge store 225 may be used to determine the measures of relevance. Based on the measures of relevance, the content selection module 235 selects content items for presentation to the user. As an additional example, the content selection module 235 selects content items having the highest measures of relevance or having at least a threshold measure of relevance for presentation to the user. Alternatively, the content selection module 235 ranks content items based on their associated measures of relevance and selects content items having the highest positions in the ranking or having at least a threshold position in the ranking for presentation to the user.

Content items selected for presentation to the user may include advertisements from ad requests or other content items associated with bid amounts. The content selection module 235 uses the bid amounts associated with ad requests when selecting content for presentation to the viewing user. In various embodiments, the content selection module 235 determines an expected value associated with various ad requests (or other content items) based on their bid amounts and selects advertisements from ad requests associated with a maximum expected value or associated with at least a threshold expected value for presentation. An expected value associated with an ad request or with a content item represents an expected amount of compensation to the online system 140 for presenting an advertisement from the ad request or for presenting the content item. For example, the expected value associated with an ad request is a product of the ad request's bid amount and a likelihood of the user interacting with the ad content from the ad request. The content selection module 235 may rank ad requests based on their associated bid amounts and select advertisements from ad requests having at least a threshold position in the ranking for presentation to the user. In some embodiments, the content selection module 235 ranks both content items not associated with bid amounts and ad requests in a unified ranking based on bid amounts associated with ad requests and measures of relevance associated with content items and with ad requests. Based on the unified ranking, the content selection module 235 selects content for presentation to the user. Selecting ad requests and other content items through a unified ranking is further described in U.S. patent application Ser. No. 13/545,266, filed on Jul. 10, 2012, which is hereby incorporated by reference in its entirety.

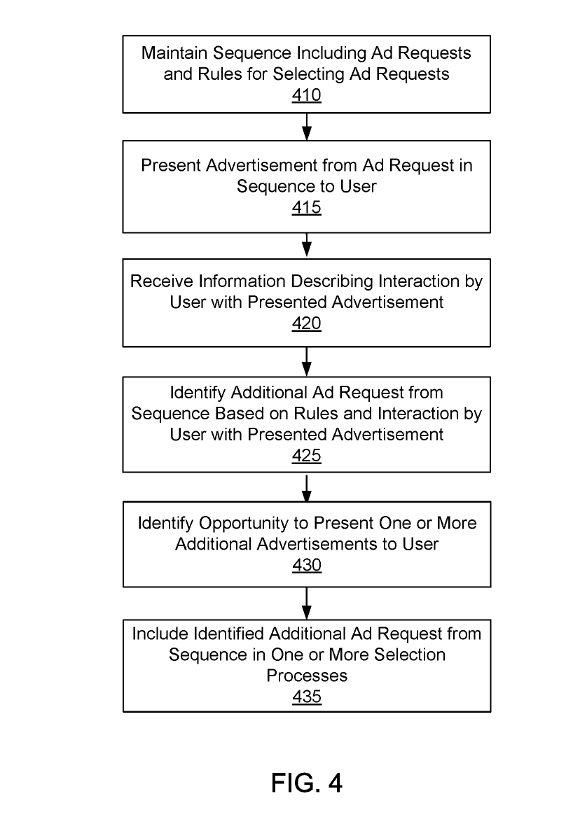

If the content selection module 235 selects an advertisement from an ad request in a sequence maintained by the ad request store 230 for presentation to a user and the user interacts with the advertisement, the action logger 215 receives information describing the interaction and stores the information describing the interaction in the action log 220 in association with information identifying the user and information identifying the ad request from the sequence. When the content selection module 235 an opportunity to present one or more advertisements to the user after information describing the user's interaction with the advertisement from the ad request in the sequence, the content selection module 235 selects an additional ad request from the sequence for inclusion in one or more selection processes based on the user's interaction with the advertisement from the ad request and the set of rules associated with the sequence, as further described below in conjunction with FIG. 4. In various embodiments, the content selection module 235 compares interactions with the advertisement from the ad request to rules associated with the sequence that identify the ad request and selects an additional ad request specified with a rule that identifies an interaction with the advertisement from the ad request matching the interaction by the user with the advertisement from the ad request. The content selection module 235 includes the selected additional ad request from the sequence in one or more selection processes, as further described above, when selecting the one or more advertisements for presentation to the user. Hence, as the user interacts with advertisements from ad requests in the sequence, the content selection module 235 subsequently evaluates different ad requests from the sequence for presentation to the user based in part on the user's interaction with the advertisements from the ad requests in the sequence, allowing the content selection module 235 to present the user with advertisements including different information based on how the user interacts with advertisements from ad requests in the sequence.

Additionally, the content selection module 235 communicates information to the action log 220 identifying ad requests from the sequence including advertisements that were previously presented to the user. For example, when the content selection module 235 communicates an advertisement from an ad request in the sequence to the user, the content selection module 235 communicates information identifying the user and identifying the ad request to the action log 220 for storage, allowing the content selection module 235 to identify a progression of the user through advertisements form various ad requests in the sequence. In some embodiments, based on information from the content selection module 235, the action log 220 identifies multiple ad requests from the sequence including advertisements that were presented to the user; alternatively, the action log 220 maintains information identifying an ad request from the sequence including an advertisement that was most recently presented to the user. In some embodiments, one or more other ad requests include targeting criteria identifying an ad request from the sequence, and the content selection module 235 determines whether the ad request from the sequence in the targeting criteria was previously presented to the user when determining if one of the other ad requests is eligible for presentation to the user. For example, another ad request includes targeting criteria identifying an ad request from the sequence, so the content selection module 235 determines the other ad request is eligible for inclusion in a selection process if information in the action log 220 indicates the user had previously been presented with an advertisement form the ad request from the sequence and determines the ad request is not eligible for inclusion in one or more selection processes if information in the action log 220 does not indicate the user was previously presented with the advertisement from the ad request from the sequence.

In some embodiments, the content selection module 235 selects an ad request from the sequence for inclusion in a selection process that selects one or more content items for presentation to a user based on a likelihood of the user interacting with advertisements from different ad requests in the sequence. In various embodiments, the content selection module 235 receives information from the action log 220 describing historical interactions by users with previously presented advertisements from ad requests having earlier positions in the sequence than a particular ad request. Based on the historical interactions by the users, the content selection module 235 determines a likelihood of the user interacting with an advertisement from the particular ad request. If the likelihood of the user interacting with the advertisement from the particular ad request equals or exceeds a threshold value, the content selection module 235 selects the particular ad request for inclusion in one or more selection processes without initially presenting the user with advertisements from ad requests having positions in the sequence earlier than the particular ad request. Conversely, if the likelihood of the user interacting with the advertisement from the particular ad request is less than the threshold value, the content selection module 235 includes one or more of the ad request having positions in the sequence earlier than the particular ad request in the one or more selection processes. For example, the content selection module 235 retrieves, from the action log 220, prior interactions with advertisements from ad requests having positions in the sequence prior to a position in the sequence of a particular ad request by users who have at least a threshold number or a threshold percentage of characteristics matching characteristics of the user. Based on the retrieved interactions, the content selection module 235 determines the likelihood of the user performing an interaction (e.g., a specific type of interaction) with an advertisement from the particular ad request. If the likelihood equals or exceeds a threshold value, the content selection module 235 includes the particular ad request in a selection process for presentation to the user, even if advertisements from one or more ad requests having earlier positions in the sequence than the particular ad request have not been previously presented to the user. Selection of ad requests from a sequence for inclusion in one or more selection processes is further described below in conjunction with FIG. 4.

For example, the content selection module 235 receives a request to present a feed of content (also referred to as a “content feed”) to a user of the online system 140. The feed may include one or more advertisements as well as content items, such as stories describing actions associated with other online system users connected to the user. The content selection module 235 accesses one or more of the user profile store 205, the content store 210, the action log 220, and the edge store 225 to retrieve information about the user and selects content items based on the retrieved information. For example, information describing actions associated with other users connected to the user or other data associated with users connected to the user is retrieved and used to select content items describing actions associated with one or more of the other users. Additionally, one or more ad requests may be retrieved from the ad request store 230. The retrieved ad requests and other content items are analyzed by the content selection module 235 to identify candidate content items that are likely to be relevant to the user. For example, content items associated with users who not connected to the user or content items associated with users for whom the user has less than a threshold affinity are discarded as candidate content items. Based on various criteria, the content selection module 235 selects one or more of the candidate content items or ad requests identified as candidate content items for presentation to the user. The selected content items or advertisements from selected ad requests are included in a feed of content that is presented to the user. For example, the feed of content includes at least a threshold number of content items describing actions associated with users connected to the user via the online system 140.

In various embodiments, the content selection module 235 presents content to a user through a feed including a plurality of content items selected for presentation to the user. One or more advertisements may also be included in the feed. The content selection module 235 may also determine an order in which selected content items or advertisements are presented via the feed. For example, the content selection module 235 orders content items or advertisements in the feed based on likelihoods of the user interacting with various content items or advertisements.

The web server 240 links the online system 140 via the network 120 to the one or more client devices 110, as well as to the one or more third party systems 130. The web server 140 serves web pages, as well as other web-related content, such as JAVA®, FLASH®, XML and so forth. The web server 240 may receive and route messages between the online system 140 and the client device 110, for example, instant messages, queued messages (e.g., email), text messages, short message service (SMS) messages, or messages sent using any other suitable messaging technique. A user may send a request to the web server 240 to upload information (e.g., images or videos) that are stored in the content store 210. Additionally, the web server 240 may provide application programming interface (API) functionality to send data directly to native client device operating systems, such as IOS®, ANDROID™, WEBOS® or BlackberryOS.

Selecting Advertisements from a Sequence of Ad Requests for Presentation to a User

FIG. 4 is a flowchart of one embodiment of a method for selecting an advertisement from a sequence of advertisement requests (“ad requests”) for presentation to a user of an online system 140. In other embodiments, the method may include different and/or additional steps than those shown in FIG. 4. Additionally, in some embodiments, the steps described in conjunction with FIG. 4 may be performed in different orders than the order described in conjunction with FIG. 4.

The online system 140 maintains multiple ad requests that, as further described above in conjunction with FIG. 2, each include an advertisement for presentation to one or more users and a bid amount specifying an amount of compensation the online system 140 receives in exchange for presenting the advertisement in the ad request to a user or in exchange for the user performing one or more interactions with the advertisement in the ad request. From the multiple ad requests, the online system 140 maintains 410 a sequence including multiple ad requests. Each ad request in the sequence includes an advertisement that at least partially differs from advertisements included in other ad requests in the sequence. As further described above in conjunction with FIGS. 2 and 3, the sequence also includes a set of rules for identifying one or more ad requests from the sequence based on interactions by a user with advertisements from ad requests in the sequence. A rule identifies an ad request in the sequence and one or more interactions that, when performed by a user, cause the online system 140 to identify another ad request in the sequence to include in one or more selection processes selecting content for presentation to the user when the online system 140 identifies an opportunity to present an advertisement to the user. For example, a rule includes an identifier of an ad request in the sequence, an interaction or a type of interaction with an advertisement included in the ad request, and an identifier of an additional ad request including an advertisement for presentation to a user if the user has performed the interaction with the advertisement included in the ad request. Hence, the set of rules specifies an order of ad requests in the sequence relative to each other, with positions of ad requests in the sequence relative to other ad requests determined by interactions by users with advertisements from the ad requests identified by various rules. Example interactions with an advertisement specified by a rule include: viewing the advertisement, viewing the advertisement for at least a threshold amount of time, viewing at least a threshold percentage of the advertisement, viewing the advertisement at least a minimum number of times, performing a specific type of interaction with the advertisement, performing at least a threshold number of a specific type of interaction with the advertisement, performing an interaction with an object associated with the advertisement, or any other suitable type of interaction.

As the online system 140 identifies one or more opportunities to present content items to a user, the online system 140 presents 415 an advertisement from an ad request in the sequence to the user. For example, the online system 140 receives a request from a client device 110 associated with the user for one or more content items, including one or more advertisements, includes one or more ad requests eligible for presentation to the user in one or more selection processes, which select the ad request from the sequence, as further described above in conjunction with FIG. 2. The online system 140 communicates the advertisement from the selected ad request to the client device 110 for presentation to the user. In some embodiments, the sequence includes information identifying an ad request from the sequence including an advertisement to be initially presented to the user (i.e., an “initial ad request”). If the online system 140 does not maintain information indicating an advertisement from an ad request in the sequence has been presented to the user, the online system 140 includes the initial ad request in the one or more selection processes, so the advertisement from initial ad request is presented 415 to the user if selected by the one or more selection processes.

Alternatively, the online system 140 includes an ad request from the sequence in the one or more selection processes based on likelihoods of the user interacting with advertisements from different ad requests in the sequence. In various embodiments, the online system 140 determines likelihoods of the user interacting with advertisements from one or more ad requests in the sequence and identifies an ad request from the sequence with which the user has at least a threshold likelihood of interacting in the one or more selection processes. For example, the online system retrieves historical interactions by users with previously presented advertisements from ad requests in the sequence that have earlier positions in the sequence than a particular ad request. Based on the historical interactions by the users, the online system 140 determines a likelihood of the user interacting with an advertisement from the particular ad request. If the likelihood of the user interacting with the advertisement from the particular ad request equals or exceeds a threshold value, the online system 140 includes the particular ad request in the one or more selection processes. In some embodiments, the online system 140 determines a likelihood of the user performing one or more specific actions with the advertisement from the particular ad request when determining whether to identify 425 the particular ad request as the additional ad request or retrieves historical interactions by users having one or more specific characteristics (e.g., at least a threshold number or a threshold percentage of characteristics matching characteristics of the user, one or more specific characteristics, such as a location, an age range, one or more interests, etc.) to determine the likelihood of the user interacting with the advertisement from the particular ad request.

When the user interacts with the presented advertisement from the ad request in the sequence via a client device 110, the online system 140 receives 420 information from the client device 110 describing the interaction with the presented advertisement. For example, the information received 420 from the client device 110 includes information identifying the user to the online system 140 (e.g., a user identifier associated with the user by the online system 140, an identifier associated with an application executing on the client device 110 presenting the content from the online system 140, an identifier associated with the client device 110 presenting the content from the online system 140, etc.). The online system 140 stores the information describing the interaction with the presented advertisement in associated with information identifying the user and an identifier of the ad request from the sequence that included the presented advertisement, allowing the online system 140 to maintain a record of advertisements presented to the user and user interactions with the presented advertisement. Example interactions with the advertisement include: viewing the advertisement, viewing the advertisement for at least a threshold amount of time, viewing at least a threshold percentage of the advertisement, viewing the advertisement at least a minimum number of times, performing a specific type of interaction with the advertisement, performing at least a threshold number of a specific type of interaction with the advertisement, performing an interaction with an object associated with the advertisement, or any other suitable type of interaction.

After storing information identifying the interaction by the user with the presented advertisement from the ad request in the sequence, the online system 140 identifies 425 an additional ad request from the sequence by applying the set of rules associated with the sequence to the information identifying the interaction by the user with the presented advertisement from the ad request from the sequence. In various embodiments, the online system 140 identifies a rule associating the ad request including the presented advertisement with an interaction matching the interaction by the user with the presented advertisement, and identifies 425 an additional ad request specified by the identified rule. For example, if the received information indicates the user accessed the presented advertisement from the ad request in the sequence, the online system 140 identifies 425 an additional advertisement specified in a rule identifying an interaction of viewing the advertisement included in the ad request from the sequence.

In some embodiments, the online system 140 identifies 425 the additional ad request from the sequence based on a likelihood of the user interacting with advertisements from different ad requests in the sequence. In various embodiments, the online system 140 determines likelihoods of the user interacting with advertisements from one or more other ad requests in the sequence and identifies 425 the additional ad request as an ad request including an advertisement with which the user has at least a threshold likelihood of interacting. For example, the online system retrieves historical interactions by users with previously presented advertisements from ad requests in the sequence having earlier positions in the sequence than a particular ad request. Based on the historical interactions by the users, the online system 140 determines a likelihood of the user interacting with an advertisement from the particular ad request. If the likelihood of the user interacting with the advertisement from the particular ad request equals or exceeds a threshold value, the online system 140 identifies 425 the particular ad request as the additional ad request without initially presenting the user with advertisements from other ad requests having positions in the sequence earlier than the particular ad request. Conversely, if the likelihood of the user interacting with the advertisement from the particular ad request is less than the threshold value, the online system 140 identifies 425 the additional ad request from the sequence based on the one or more rules, as further described above in conjunction with FIGS. 2 and 3. In some embodiments, the online system 140 determines a likelihood of the user performing one or more specific actions with the advertisement from the particular ad request when determining whether to identify 425 the particular ad request as the additional ad request. Additionally, the online system 140 may retrieve historical interactions by users having one or more specific characteristics (e.g., at least a threshold number or a threshold percentage of characteristics matching characteristics of the user, one or more specific characteristics, such as a location, an age range, one or more interests, etc.) to determine the likelihood of the user interacting with the advertisement from the particular ad request.

The online system 140 identifies 430 an opportunity to present one or more additional content items, including one or more additional advertisements, and includes 435 the identified additional ad request in one or more selection processes that select content for presentation to the user. For example, the online system 140 receives a request for one or more advertisements from the client device 110 associated with the user identifying an opportunity to present one or more advertisements to the user; and includes 435 the identified additional ad request in one or more selection processes selecting content for presentation to the user. The online system 140, in some embodiments, identifies 425 the additional ad request from the sequence in response to identifying 420 the opportunity to present one or more content items to the user. In some embodiments, the online system 140 also includes another ad request including targeting criteria specifying presentation of the advertisement from the ad request in the sequence to the user if the online system 140 stores information indicating the advertisement from the ad request in the sequence was presented 415 to the user. If the one or more selection processes select the additional ad request from the sequence for presentation, the online system 140 communicates the advertisement from the additional ad request to the client device 110 associated with the user for presentation. In various embodiments, the online system 140 also stores information identifying the advertisement from the ad request and was presented to the user in association with information identifying the user.

In some embodiments, the online system 140 communicates information describing presentation of advertisements from different ad requests in the sequence to a user who provided the sequence to the online system 140. For example, the online system 140 communicates information identifying different ad requests in the sequence and a number of users who were presented with advertisements from the different ad requests or who performed one or more interactions with advertisements from the different ad requests. Based on the received information, the user who provided the sequence to the online system 140 may identify a number of users who viewed advertisements from ad requests in the sequence in different orders relative to each other based on the set of rules included in the sequence. The user who provided the sequence to the online system 140 may modify the set of rules based on the received information to modify the order in which advertisements in various ad request in the sequence are presented relative to each other, allowing the user who provided the sequence to modify the order in which various advertisements are presented relative to each other. Alternatively, the user who provided the sequence to the online system 140 may modify the sequence by adding, removing, or modifying ad requests in the sequence based on the received information and communicate the modified sequence to the online system 140. After receiving the modified sequence, the online system 140 subsequently selects ad requests for inclusion in selection processes based on the modified sequence or based on the modified set of rules included in the sequence.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

1. A method comprising:
maintaining a sequence of advertisement requests (“ad requests”) at an online system, each ad request in the sequence including different advertisements for presentation, and a set of rules for identifying one or more ad requests from the sequence based on interaction with advertisements from ad requests in the sequence;
presenting an advertisement from an ad request in the sequence to a user of the online system, the ad request selected from the sequence based on likelihoods of the user performing a specific action with each ad request in the sequence determined from historical interactions by users;
receiving information describing an interaction with the presented advertisement by the user;
identifying an additional ad request from the sequence by applying the set of rules for identifying one or more ad requests from the sequence to the received information describing the interaction with the presented advertisement;
identifying an opportunity to present one or more advertisements to the user; and
including the additional ad request in one or more selection processes selecting content for presentation to the user.

2. The method of claim 1, wherein identifying the additional ad request from the sequence by applying the set of rules for identifying one or more ad requests from the sequence to the received information describing the interaction with the presented advertisement comprises:
identifying a rule from the set of rules specifying an interaction with the advertisement from the ad request matching the interaction by the presented advertisement by the user; and
identifying an additional ad request specified by the identified rule.

3. The method of claim 1, wherein an interaction with the advertisement from the ad request in the sequence is selected from a group consisting of: viewing the advertisement from the ad request in the sequence, viewing the advertisement from the ad request in the sequence for at least a threshold amount of time, viewing at least a threshold percentage of the advertisement from the ad request in the sequence, viewing the advertisement from the ad request in the sequence at least a minimum number of times, expressing a preference for the advertisement from the ad request in the sequence, sharing the advertisement from the ad request in the sequence with another user of the online system, and any combination thereof.

4. The method of claim 1, wherein the interaction with the advertisement from the ad request in the sequence comprises performing an interaction with an object associated with the advertisement from the ad request in the sequence.

5. The method of claim 1, wherein presenting the advertisement from the ad request in the sequence to the user of the online system comprises:
presenting the advertisement from the ad request in the sequence to the user of the online system; and
storing information in the online system identifying the ad request in the sequence and indicating the advertisement from the ad request in the sequence was presented to the user.

6. The method of claim 5, wherein including the additional ad request in one or more selection processes selecting content for presentation to the user comprises:
including another ad request including targeting criteria specifying presentation of the advertisement from the ad request in the sequence to the user in the one or more selection processes based at least in part on the stored information indicating the advertisement from the ad request in the sequence was presented to the user.

7. The method of claim 1, wherein identifying the additional ad request from the sequence by applying the set of rules for identifying one or more ad requests from the sequence to the received information describing the interaction with the presented advertisement comprises:
determining a likelihood of the user interacting with an advertisement from a particular ad request in the sequence; and
identifying the particular ad request as the additional ad request in response to determining the likelihood of the user interacting with the advertisement from the particular ad request in the sequence equals or exceeds a threshold value.

8. The method of claim 7, wherein identifying the additional ad request from the sequence by applying the set of rules for identifying one or more ad requests from the sequence to the received information describing the interaction with the presented advertisement comprises:
identifying the additional ad request from a rule including an interaction with the advertisement from the ad request matching the interaction by the presented advertisement by the user.

9. The method of claim 7, wherein determining the likelihood of the user interacting with the advertisement from the particular ad request in the sequence comprises:
retrieving interactions by one or more additional users with one or more advertisements from ad requests in the sequence having positions in the sequence earlier than a position in the sequence of the particular ad request; and
determining the likelihood of the user interacting with the advertisement based at least in part on the retrieved interactions.

10. The method of claim 9, wherein the one or more additional users have at least a threshold number of characteristics matching characteristics of the user.

11. The method of claim 7, wherein determining the likelihood of the user interacting with the advertisement from the particular ad request in the sequence comprises:
determining a likelihood of the user performing a specific interaction with the advertisement from the particular ad request.

12. A computer program product comprising a non-transitory computer-readable storage medium having instructions encoded thereon that, when executed by a processor, cause the processor to:
maintain, a sequence of advertisement requests (“ad requests”) at an online system, each ad request in the sequence including different advertisements for presentation, and a set of rules for identifying one or more ad requests from the sequence based on interaction with advertisements from ad requests in the sequence;
present an advertisement from an ad request in the sequence to a user of the online system the ad request selected from the sequence based on likelihoods of the user performing a specific action with each ad request in the sequence determined from historical interactions by users;
receive information describing an interaction with the presented advertisement by the user;
identify an additional ad request from the sequence by applying the set of rules for identifying one or more ad requests from the sequence to the received information describing the interaction with the presented advertisement;
identify an opportunity to present one or more advertisements to the user; and
include the additional ad request in one or more selection processes selecting content for presentation to the user.

13. The computer program product of claim 12, wherein the instructions encoded on the computer readable storage medium that, when executed by the processor, cause the processor to identify the additional ad request from the sequence by applying the set of rules for identifying one or more ad requests from the sequence to the received information describing the interaction with the presented advertisement comprise instructions that, when executed, cause the processor to:
identify a rule from the set of rules specifying an interaction with the advertisement from the ad request matching the interaction by the presented advertisement by the user; and
identify an additional ad request specified by the identified rule.

14. The computer program product of claim 12, wherein an interaction with the advertisement from the ad request in the sequence is selected from a group consisting of: viewing the advertisement from the ad request in the sequence, viewing the advertisement from the ad request in the sequence for at least a threshold amount of time, viewing at least a threshold percentage of the advertisement from the ad request in the sequence, viewing the advertisement from the ad request in the sequence at least a minimum number of times, expressing a preference for the advertisement from the ad request in the sequence, sharing the advertisement from the ad request in the sequence with another user of the online system, and any combination thereof.

15. The computer program product of claim 12, wherein the instructions encoded on the computer readable storage medium that, when executed by the processor, cause the processor to present the advertisement from the ad request in the sequence to the user of the online system comprise instructions that, when executed, cause the processor to:
present the advertisement from the ad request in the sequence to the user of the online system; and
store information in the online system identifying the ad request in the sequence and indicating the advertisement from the ad request in the sequence was presented to the user.

16. The computer program product of claim 15, wherein the instructions encoded on the computer readable storage medium that, when executed by the processor, cause the processor to include the additional ad request in one or more selection processes selecting content for presentation to the user comprise instructions that, when executed, cause the processor to:
include another ad request including targeting criteria specifying presentation of the advertisement from the ad request in the sequence to the user in the one or more selection processes based at least in part on the stored information indicating the advertisement from the ad request in the sequence was presented to the user.

17. The computer program product of claim 12, wherein the instructions encoded on the computer readable storage medium that, when executed by the processor, cause the processor to identify the additional ad request from the sequence by applying the set of rules for identifying one or more ad requests from the sequence to the received information describing the interaction with the presented advertisement comprise instructions that, when executed, cause the processor to:
determine a likelihood of the user interacting with an advertisement from a particular ad request in the sequence; and
identify the particular ad request as the additional ad request in response to determining the likelihood of the user interacting with the advertisement from the particular ad request in the sequence equals or exceeds a threshold value.

18. The computer program product of claim 17, wherein the instructions encoded on the computer readable storage medium that, when executed by the processor, cause the processor to identify the additional ad request from the sequence by applying the set of rules for identifying one or more ad requests from the sequence to the received information describing the interaction with the presented advertisement comprise instructions that, when executed, cause the processor to:
identify the additional ad request from a rule including an interaction with the advertisement from the ad request matching the interaction by the presented advertisement by the user.

19. The computer program product of claim 17, wherein the instructions encoded on the computer readable storage medium that, when executed by the processor, cause the processor to determine the likelihood of the user interacting with the advertisement from the particular ad request in the sequence comprise instructions that, when executed, cause the processor to:
retrieve interactions by one or more additional users with one or more advertisements from ad requests in the sequence having positions in the sequence earlier than a position in the sequence of the particular ad request; and
determine the likelihood of the user interacting with the advertisement based at least in part on the retrieved interactions.

20. The computer program product of claim 19, wherein the one or more additional users have at least a threshold number of characteristics matching characteristics of the user.
